(19) United States
(12) Patent Application Publication
(10) Pub. No.: US 2013/0308310 A1
(43) Pub. Date: Nov. 21, 2013

(54) LED LAMP AND METHOD

(71) Applicant: Sylwester D. Wilk, Ynkers, NY (US)

(72) Inventor: Sylwester D. Wilk, Ynkers, NY (US)

(21) Appl. No.: 13/472,091

(22) Filed: May 15, 2012

(51) Int. Cl. F21V 29/00; F21V 17/04

(52) U.S. Cl. CPC F21V 29/22; F21V 17/04
USPC 362/235; 362/249.02; 29/825

(57) ABSTRACT

LED lamps are provided with cooling fan and heat sink units adapted from such units used in cooling computer components, which are engineered to provide long-life and exemplary cooling at a moderate cost and small size.

Portable lamps, including flashlights, trouble lights, and lanterns, as well as threaded lamps, are provided with such cooling units and benefit from the compact, long-lived qualities of those units to preserve the LED units and allow them to achieve their longevity potential.

This invention relates to LED lamps, and particularly to relatively high power lamps with cooling means for the LED light-producing elements. Priority is claimed from Provisional Patent Application Ser. No. 61/413,420 filed Nov. 13, 2010, and U.S. patent application Ser. No. 12/931,540 filed Feb. 2, 2011, and U.S. patent application Ser. No. 13/136,707, filed Aug. 8, 2011. The disclosures of those applications hereby are incorporated herein by references.

LED lamps are becoming more popular because they are much more efficient than incandescent or fluorescent lighting, and therefore require much less energy, but also because the LED lamp normally lasts thousands of hours, under normal use, without requiring replacement.

One continuous problem is the initial cost of such lamps. Even though the lamps may be more economical to use, when their purchase price is amortized over the very long life of the lamps, the relatively high initial cost is a deterrent to the purchase and use of such lamps.

A further problem with such lamps is that when LED lamps of relatively high wattage, such as 20 Watts to 100 Watts are used, the LED lamp arrays (the light-producing elements) usually need cooling. Therefore, in some prior LED lamps, relatively expensive, high-throughput fans and ductwork often have been proposed for use in cooling the LED lamp arrays. This equipment not only is relatively expensive, but it also is bulky so that it is relatively difficult to fit the lamps into cramped spaces.

A particular problem exists with recessed lighting or so-called “down lamps.” The fact that the lamps are recessed in the ceiling of a room confines the lamp to fairly cramped quarters and makes the handling and installation of the units relatively difficult and expensive.

Similar problems are suffered by outdoor lighting fixtures such as street lamps.

Certain lamps are known as “work lights” or “work lamps.” These are lamps used, typically, by painters, plumbers, construction workers, home owners, etc., to light indoor and outdoor building and other work sites. Typically, such lamps use incandescent, fluorescent, halogen or LED light sources.

Halogen work lamps emit high intensity light, but they can get very hot during use and therefore usually use heavy wire shields over the outlet light window to prevent burns. Also, the bulbs bum out relatively quickly so that spares usually are kept on hand, and the cost of replacing bulbs can be significant.

LED work lamps are available, but usually are relatively expensive and are limited in output light intensity.

Similar problems exist with LED automobile headlights; that is, existing LED headlamps usually have limited light output, and are overly expensive.

Portable LED lamps, such as flashlights and emergency lights, which are operated by battery, are known and available. However, if the light output they give is at a relatively high level, the structures of such portable lamps are relatively large, heavy and expensive, primarily due to the heat exchangers which extend from the outside of the flashlight or the lamp. This also makes the lamps relatively expensive.

Similar problems exist with threaded LED lamps, which are offered as substitutes for standard threaded incandescent or halogen light bulbs. Such units usually are relatively large, expensive to manufacture, and therefore expensive to buy. Furthermore, the cooling structures provided for such lamps in the past and the lamp structures themselves are believed to be specialized and not well-suited to high volume manufacturing at moderate cost.

Therefore, it is an object of the present invention to provide LED lamp structures and manufacturing methods which remedy or alleviate the foregoing problems.

More particularly, it is an object to provide an LED lamp structure which is relatively inexpensive, compact, and easy to install, and manufacturing methods having comparable attributes.

It is a further object of the invention to provide such a lamp structure which eliminates the need for expensive ducting and other ancillary structures.

In accordance with the present invention, the foregoing objectives are met by utilizing LED cooling units comprising fan and heat sink to provide optimal cooling of electronic components in computers; cooling at a moderate cost and with a relatively small size, and with a long useful life commensurate with the desired useful life of the component being cooled. This enables the LED to achieve its inherently long life by maintaining the temperature of the LED within values needed to achieve longevity.

The heat exchanger structure in the heat sink can consist of fins, heat pipes, and combination of those items.

The fans can have cowlings (housings) and be mounted to the outside of the heat sink, or can be mounted inside the heat sink, as noted above.

In accordance with one embodiment of the present invention, the foregoing objectives are met by the provision of a LED lamp fixture with a heat sink structure to which the LED array is attached directly, with a fan mounted nearby. The heat sink is a heat exchanger to remove heat from the LED. In one embodiment, the heat sink has a central area without fins, and the fan is mounted in the central area of the heat sink structure so as to give the lamp a relatively low profile and make the lamp structure compact and relatively easy to fit into recessed spaces. The fan blades are shaped so as to push the air sideways through the spaces between the fins, or they are shaped to push or pull the air through the heat sink.

The fan/heat sink structure can be comparatively inexpensive and compact, in part because the preferred devices are those that have been produced in great quantities for use in computers. Not only are they relatively compact and inexpensive, but the applicant has found that such units are very efficient in cooling LED lamps, when they are correctly positioned.

The applicant has realized also that the fans can be mounted in recessed housings in buildings in the air spaces between the ceiling and the floor above it, and discharge the air flow directly into that air space, without use of expensive ducting. This is believed to be because the air flow rate is relatively low and the air escapes sufficiently rapidly through natural crevices and cracks in the building structure.

The applicant has applied the same principles in simplifying the construction of outdoor lighting appliances such as street lamps using LED lamps. Cooling fan air is exhausted directly into the housing of the lamp where it easily escapes through natural crevices in the lamp structure.

The same advantageous LED lamp structure is used to advantage in a work light or work lamp which is a portable lamp, with its own support structure, which is used to give bright illumination for professional painters, carpenters and other workers, as well as for non-professional workers. The lamp output usually can be tilted to shine upwardly from the floor or around at a variable angle.

The lamp structure is used to further advantage in vehicle headlights such as automobile or truck headlights, to provide a reliable, low power-consumption, relatively low cost headlight package.

A back-up battery emergency power supply is provided as well. Because the LED lamp usually draws fewer watts of electrical energy for a given light output than many other lamps, the lamp of the invention can continue providing light for a substantial time after the normal power source has failed.

This invention is used to advantage in making flashlights, emergency lights and other portable battery-powered lamps. The small size of the fan and the heat sink makes it fit inside the casing of a flashlight or an emergency light, and no heat exchanger fins need extend outwardly into the surrounding air to dissipate heat.

Also, threaded LED replacement units for incandescent and halogen bulbs are provided in a very compact structure which fits well into lighting fixtures and advantageously uses the driver circuitry for the LED also to drive the small fan used to cool the LED.

The great simplification of the air flow structures used in the invention is aided by the efficiency of the heat sink structures used in the invention, thereby minimizing the quantity of airflow required.

The foregoing and other objects and advantages of the invention will be set forth in or apparent from the following description and drawings.

### IN THE DRAWINGS

FIG. 1 is a perspective view of a lamp fixture embodiment of the present invention;

FIG. 2 is a cross-sectional view of the lamp fixture installed in a typical location, with a cross-sectional view of the lamp being taken along Line 2-2 of FIG. 1.

FIG. 3 is a cross-sectional view, like that of FIG. 2, of a different LED lamp fixture of the present invention;

FIG. 4 is a cross-sectional view taken along Line 4-4 of FIG. 3;

FIG. 5 is a perspective view of a heat sink and fan structure used in the lamp fixtures of FIGS. 1-4;

FIG. 6 is a cross-sectional view of another lamp fixture embodiment of the present invention;

FIG. 7 is a broken-away view take along Line 7-7 of FIG. 6; and

FIG. 8 is a top plan view of a component of the structure shown in FIG. 6.

FIG. 9 is a perspective view of a work light utilizing the invention;

FIG. 10 is a cross-sectional view, taken along line 10-10 of FIG. 9;

FIG. 11 is a rear elevation view, partially broken-away, showing a component of the FIG. 9 structure;

FIG. 12 is a perspective view of the invention used to advantage in an automobile headlight module;

FIG. 13 is a broken-away rear elevation view of the FIG. 12 structure;

FIGS. 14 and 15 are broken-away side elevation schematic and cross-sectional views of the structures in FIG. 12;

FIGS. 16 and 17 are schematic circuit diagrams of battery back-up power supplies for the LED lamps of the invention;

FIG. 18 is a side elevation and cross-sectional schematic view of a flashlight incorporating the invention;

FIG. 19 is a cross-sectional view taken along line 19-19 of FIG. 18;

FIG. 20 is a partially schematic cross-sectional view of another flashlight utilizing the present invention;

FIGS. 21 and 22 are examples of luminaires using lamps constructed by use of the present invention;

FIG. 23 is a partially cross-sectional, partially schematic view of a portable emergency light or lantern for indoor or outdoor use;

FIG. 24 is a cross-sectional, partially schematic view of a threaded LED lamp fixture utilizing the present invention;

FIG. 25 is a side elevation view of another threaded LED lamp fixture using the present invention; and

FIG. 26 is a schematic perspective view of a battery recharging system usable with lamps such as some of those described above.

### FLOODLIGHT FIXTURE

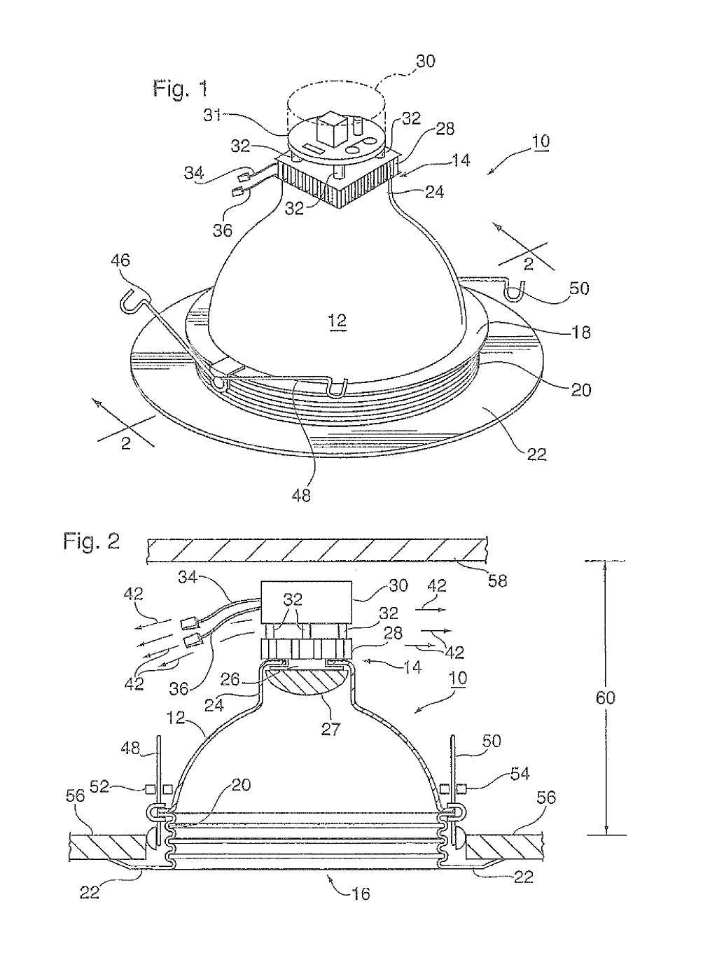

FIG. 1 shows a fixture 10 which is termed herein a “floodlight” fixture, in that it is of the type which normally receives an incandescent or other screw-in type bulb in a socket, and the bulb spreads light outwardly over a relatively wide area.

The fixture includes a bell-shaped housing 12 having an inlet opening at 14 and an outlet opening at 16 (FIG. 2) where light leaves the fixture.

The housing has a flange 22 with corrugated section 20 near its outlet end 16, and a relatively straight neck portion 24 leading to the inlet 14.

Instead of the usual incandescent lamp or other screw-in lamp, an LED array 26 is positioned at the inlet opening just inside the housing. The LED array 26 emits its light through a convex lens 27 which tends to spread the light outwardly. Alternatively, other lenses could be provided to shape the output light beam as desired.

Referring to FIG. 2, as well as FIG. 4, the LED array 26 has a central array 70 of LED light elements, in a package having flanges 64 and a body portion (behind the array 70 in FIG. 4). The body portion extends through the opening 14 and makes contact with the flat bottom of a heat sink 28. The LED array is attached to the flat bottom of the heat sink preferably by heat-conducting silicone thermal glue. Thus, the body of the LED array makes intimate, heat-conducting contact with the bottom of the metal heat sink.

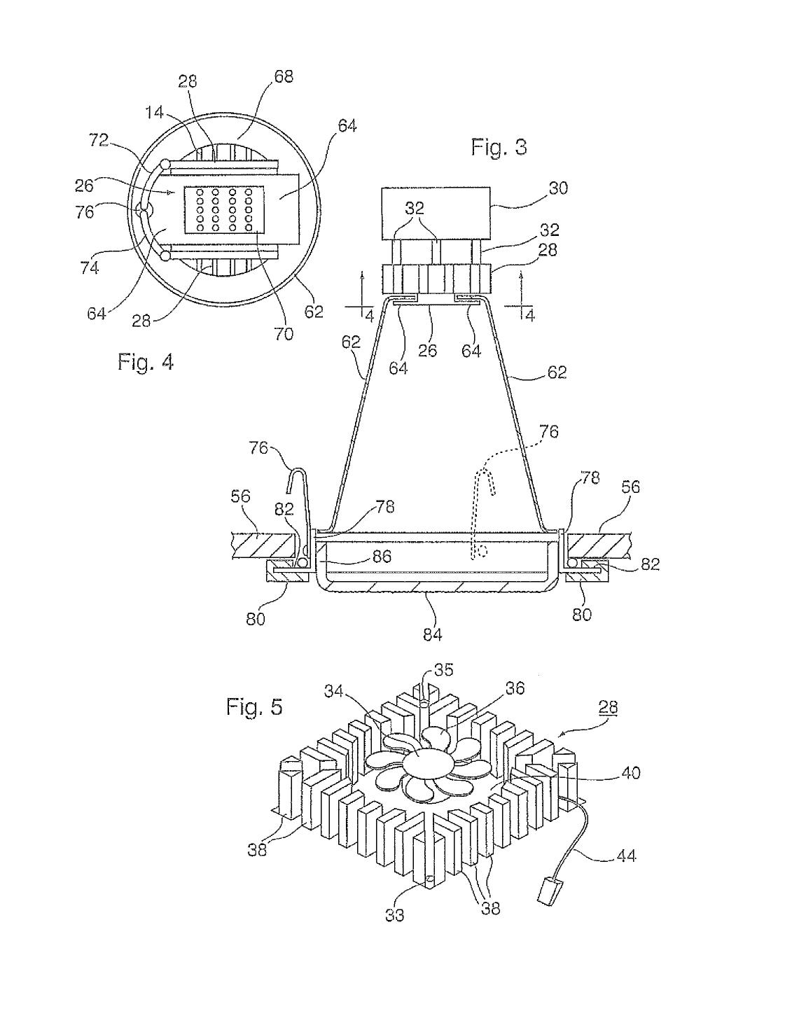

Referring to FIG. 2, as well as FIGS. 1 and 3, a power supply 30 is provided. It is mounted above and spaced from the upper surface of the heat sink 28 by screws and spacers 32 (not shown in FIG. 1). The power supply 30 may or may not have a cover such as that shown in FIGS. 2 and 3, and in dashed outline in FIG. 1.

Input leads 34 and 36 to the power supply are connected directly to the wiring of the building to supply the usual 120 Volts 60 Hz AC power. The power supply has a well-known construction. It typically uses a step-down transformer and a rectifier to convert AC voltage to 12 Volts DC for the fan motor, and 14 Volts DC for the LED array. Although separate power supplies can be provided for the two devices, a single power supply combining these functions is compact and relatively simple to mount and can be provided relatively inexpensively.

The preferred heat sink 28 and fan combination is shown in FIG. 5. The heat sink preferably is made out of aluminum or similar light-weight, inexpensive good heat-conducting material. The heat-sink has a hollowed-out body with a central cavity 40, and a plurality of fins 38. A fan 34 with blades 36 forces air out sideways between the fins to provide cooling.

The fan and heat sink combination shown in FIG. 5 is used for cooling VGA cards in computers. It is relatively inexpensive because it is manufactured in great quantities for use in computers around the world.

The fan 34 and heat-sink 28 combination is highly advantageous for use in the present invention in that its vertical height is quite small. This keeps the height of the structure above the inlet end of the lamp 12 housing relatively low. Thus, the fixture can be used in the space between the ceiling and floor in a building, as shown in FIG. 2, or in other cramped spaces without undue difficulty.

The power supply 30 preferably has a round, flat circuit board 31 (FIG. 1) on which the components are mounted. This board serves as a baffle for air flowing to or from the fan, so as to insure that the air will travel sideways as indicated in FIG. 2 by the arrows 42. This additionally gives some cooling, if needed, to the power supply.

It is preferred that the power supply has a thermistor which will open the power circuit to the LED lamp if and when it overheats due to failure of the fan, or a circuit like a light dimmer circuit which reduces the power delivered to the LED lamp when it overheats, usually by pulse-width modulation, until the lamp cools sufficiently.

Referring again to FIG. 5, the heat sink 28 has mounting holes 33 and 35, but other mounting holes can be provided as needed.

The power supply cord 44 to the fan 34 is connected into the power supply 30 through a connection which is not shown in the drawings.

Referring again to FIGS. 1 and 2, two pairs of spring arms, 46, 48, and 50 are provided on opposite sides of the housing 12. As it is well known, the spring arms are inserted into mounting receptacles, part of which are shown at 52, to retractably mount the fixture in the opening in the ceiling.

FIG. 2 shows the ceiling 56 and schematically shows the floorboards 58 of the floor above the ceiling 56. This provides an air space between the floorboards and the ceiling. That air space is indicated at 60 in FIG. 2.

In accordance with one highly advantageous feature of the invention, the air discharged from the fan is discharged sideways directly into the air space 60 without the use of ducting or other expensive construction features. This is due to the realization that the air need not be vented into the room below or elsewhere because it is easily able to escape through the normal crevices and openings in building construction air spaces.

Furthermore, it is an advantage of the invention that the fans that are selected are very low volume in their output because the heat-sink and fan arrangement is so efficient in carrying heat away from LED lamp arrays. Therefore, the output air volume is relatively low and can be essentially negligible.

### Shower Fixture

FIG. 3 shows a shower lamp fixture which is like that shown in FIG. 2, with certain exceptions. A frustro-conical housing 62 is provided with a glass outlet cover 82 with a rough pebbled outer surface 84 and a bezle 80. A rubber seal (not shown) is provided between the bezle and the ceiling 56 to make the fixture reasonably watertight so it can be used readily in showers or other wet areas.

Three convenient hook fasteners 76 (only two of which are shown) are provided for the easy mounting of the fixture in a ceiling mounting structure, as is well known. The bezle 80 is secured to the lower flange 82 of the housing 62.

In other respects, the function of the structure of the fixture in FIG. 3 is like the one shown in FIGS. 1 and 2.

### Outdoor Light Fixtures

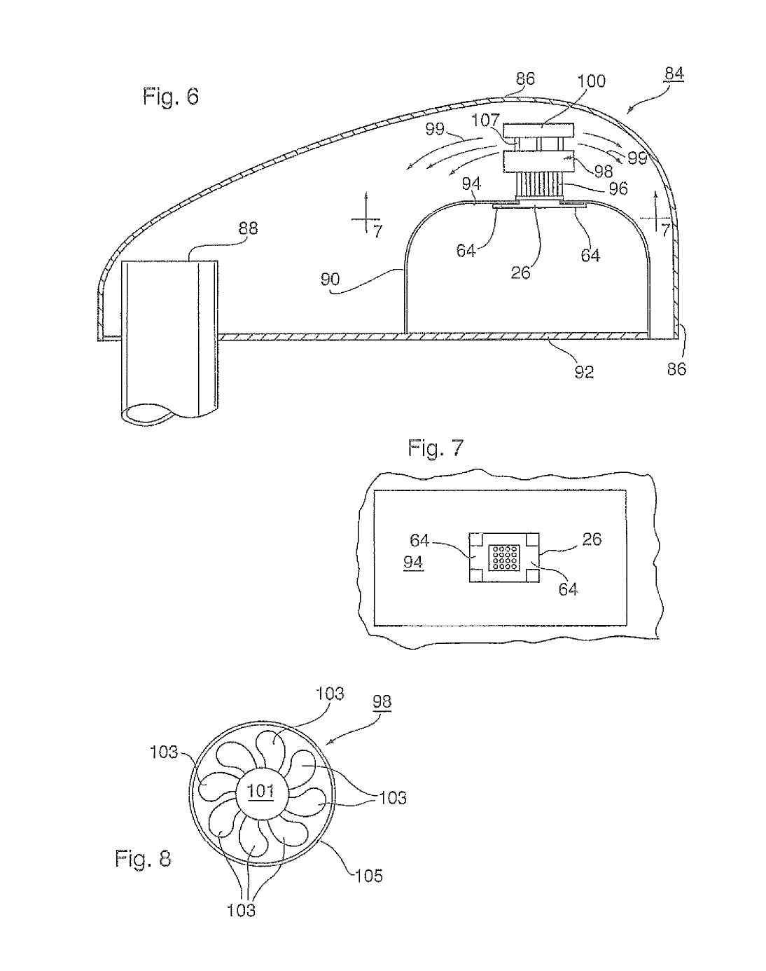

FIG. 6 is a cross-sectional view of a typical street lamp housing 86, which is mounted on a pole indicated schematically at 88, for street lighting purposes. Whereas the LED array used in the fixtures shown in FIGS. 1, 2 and 3 are relatively low power (e.g. 20 Watts to 50 Watts) which give illumination in the range of 60 Watt incandescent bulbs to 150 Watt incandescent bulbs, the street lighting fixture shown in FIG. 6 usually requires higher wattage for LED arrays, say 100 Watts or more. As a result, more cooling is required.

The LED array 26 is mounted in a reflector 90 within the housing 86 to reflect light from the LED lamp array outwardly through a window 92.

The fixture 84 shown in FIG. 6 has a single fan 98 in a circular housing mounted on top of a heat sink 96, and a power supply is mounted at 100 above the fan 98. The fan 98 draws air upwardly though the heat sink 96 and spreads it sideways in the directions of the arrows 99.

Because there is more room in the housing of lighting fixture 84 than for the fixtures in FIGS. 1-5, there is sufficient room for the more powerful but taller fan 98 and heat-sink 96 combination to be used.

FIG. 8 is a top plan view of the fan 98. It has a circular housing 105 with a fan motor 101 with blades 103 mounted within the housing 99. The housing and fan are mounted on the heat sink 96 by screws and spacers 107.

Preferably, this fan, like the fan 34 used in the fixtures shown in FIGS. 1-3 is used in cooling computers. Specifically, it is used to cool the CPU units in desk-top and other computers.

Alternatively, a fan and heat-sink combination like that in FIGS. 1-5 but with a higher output volume can be used, in order to keep the profile low.

Again, the air from the fan is simply discharged into the interior of the housing 86, from which it escapes easily through the small crevices and gaps occurring in such structures.

### Work Lights

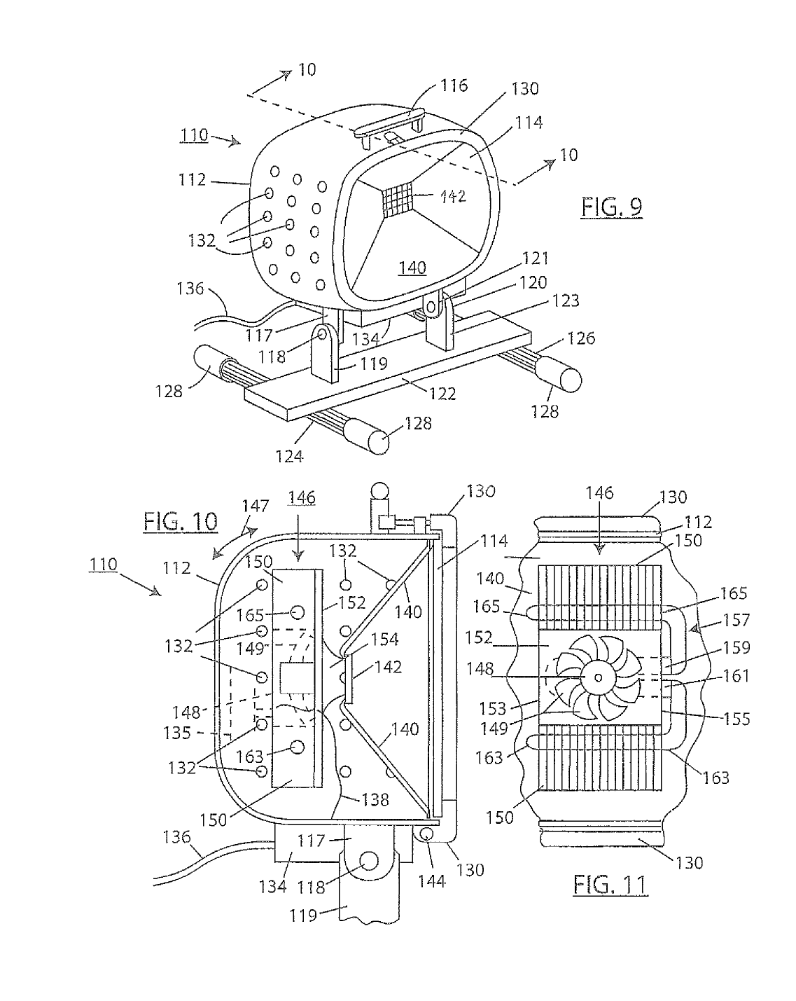

FIG. 9 is a perspective view of a work light or work lamp 110 provided in accordance with the invention.

As it is well known, work lights are used by painters, brick and tile layers, homeowners and others who need to have a well-lit work area, either indoors or outdoors, in which to perform their work.

Work lights are used indoors to light up dark rooms, or to light dark areas in basements or elsewhere to give adequate light to work by. Work lights also are used outdoors to illuminate work objects and areas, especially at night or on dark days.

The work light 110 includes a metal housing 112, a front glass window 114, a carrying handle 116 on top of the housing 112, and a support structure including mounting legs 117 and 121 extending downwardly from the housing 112, and support legs 119 and 123 coupled to the legs 117 and 121 by pivotable connections 118 and 120. The pivotable connections allow the work light housing 112 to be pivoted forward and backward, in the directions indicated by arrow 147 (FIG. 10), to tilt the light up or down, as needed. As it is well known, the tilt mechanism will hold the housing at the angle to which it is set.

The supports 119 and 123 are secured, as by bolts or welding, to a metal crossbar 122 which is secured to transverse support pipes 124 and 126 with rubber feet 128 to provide a stable support platform for the work light.

The work light 110 shown in FIG. 9 is relatively large work light of the size which normally uses a 500 watt halogen bulb to produce a great deal of output light power.

There are many other variations on the constructions of work lights, and the invention is believed to be usable in all or at least the vast majority of such devices, with moderate modifications which are within the skill of the art to provide.

Referring now to FIGS. 9 and 10, behind the light outlet window 114 is a shiny metal reflector 140 which reflects the light from the lamp and through the window 114.

At the center of the reflector 140 is an LED array 142. In this case, the LED array is one which requires 100 watts of power and is said by its manufacturer or seller to produce white light with an intensity of approximately 8000 lumens. This is a very powerful light.

Referring particularly to FIG. 10, there is provided a heat-sink/fan cooling device 146. The device 146 consists of a conductive plate 152 from which extend a plurality of metallic fins 150 (also see FIG. 11) on opposite sides of a fan motor 148 with fan blades 149. Extending from the plate 150 is an extension structure 154, also thermally conductive, which is fastened to the support substrate of the LED array by electrically conductive glue.

The heat-sink and fan combination 146 preferably is one like those used for cooling computer video cards, such as the “Super Silent Professional Video Card Heat Pipe Cooler,” sold by Dealer Extreme (dealerextreme.com). It uses a 2500 rpm fan.

The blades 149 of the fan 148, like the blades of the fan used in the embodiment of FIGS. 1-5, are shaped with squared-off tips and are otherwise shaped to throw air outwardly laterally to flow in the spaces between the fins 150. The structure 146 has side-walls 153 and 155 which tend to guide air from the blades 149 towards the fins 150.

The structure 146 also has a heat-pipe structure 157 to increase its cooling capabilities. The heat pipe consists of a sealed copper tube with two central sections 159 and 161, which are somewhat flattened in the flat plane of the projection 154 to which the LED array 142 is secured to make good thermal contact with the surface to be cooled, and two end portions 163 and 165. The end portions 163 and 165 extend through holes in the fins 150 so as to transfer heat conducted from the LED array into the heat pipe into the fins 150 where the heat is removed by the fan 148.

Mounted on the outside of the housing 112, at the bottom thereof is a metal housing 134 secured to the bottom of the housing 112, which contains the power supply for the LED array and fan, and is connected to the LED and fan by conductors indicated at 138.

An alternative location for the power supply is inside the housing, at a location indicated by the reference numeral 135. Spacers attach the power supply to the heat sink, as in the FIGS. 1-5 embodiments. This location is preferred if there is sufficient room in the housing 112.

Electrical power is supplied to the circuitry in the housing 134 by means of a cord 136. Typically, this power will be either 120 volts or 230 volts AC. The AC voltage is converted to the necessary DC voltages required by the fan and LED array, as described herein above.

The housing 112 optionally has a plurality of holes 132 at opposite sides of the housing walls to serve as ventilation ports. These need not be provided if there are sufficient crevices or openings in the housing due to its natural construction to provide adequate egress for the cooling air developed by the fan 148.

If desired or necessary, the power supply can include a thermistor to shut off the power, or a light dimmer control circuit to cool off the LED array, should it overheat, due to failure of the fan, temporary occlusion of the air vent holes, or other abnormal causes.

It is believed that the structure shown for the work light provides more light than usually is available in work lights, and yet at a cost which is not prohibitively high. It is believed that the light output from the work lamp can be greater than that presently available for most work lamps, but without the excessive heating of the glass window, and without the short life of halogen bulbs when halogen lighting is used.

It is believed, as with other LED lamps disclosed herein, the life of the LED array can be as high as 50,000 hours or more.

### Automobile Headlights

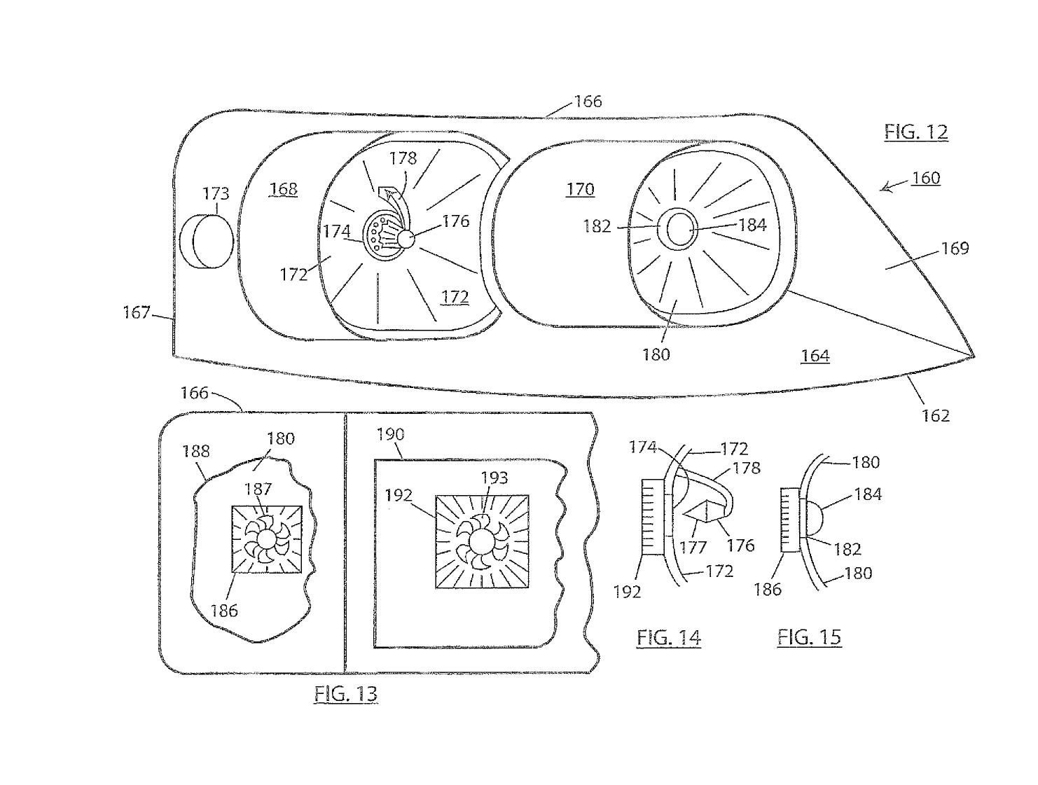

FIG. 12 is a perspective view of a headlight module 160 which fits into one of the right-receptacle if the front-end of a modem automobile. The particular unit shown forms the right side headlight module when viewing the automobile from the driver's seat, and there will be another module, a mirror-image of the module 160, at the left front corner of the vehicle.

In accordance with the present invention, the usual incandescent or halogen lamps have been replaced by LED lamps.

Module 160 comprises a body 166, usually molded of plastic materials, having a floor 164, side walls 165 and 167, and a transparent molded plastic window 162, which covers the entire front of the module 160 shown in FIG. 12 so light from two headlights 168 and 170 within the module can shine through and forwardly of the automobile to guide it.

The lamp 168 is the “high beam” or high intensity lamp, and the lamp 170 is the “low beam” headlamp. A turn signal lamp 173 also is present in the module.

The high beam lamp 168 includes a reflector 172 with a centrally-located circular LED array 174, and a central beam shaper 176 mounted on an arm 170 which is attached to the structure of the reflector 172.

As it is shown in FIG. 14, the beam shaper 176 has a conical-shaped forward end 178. The purpose of this is to shape the high beam properly.

The low-beam lamp 170 includes a reflector 180, a central circular LED array 182, and a convex lens 184 covering the LED array and shaping the light that it emits.

FIG. 13 is a partially broken-away and partially schematic rear view of the housing 166 with exit doors 188 and 190 open to show the heat sinks and the fans of the two LED lamps.

Through the opening 188, can be seen a heat sink 186 with a fan 187 as shown in FIGS. 1-5. The LED array 182 is attached to the heat sink in the same manner as the LED array is attached to the heat sink as shown in FIG. 1. Preferably, the light from the LED array 182 is not as bright as that from the other LEDs.

The LED array for the lamp 168 has a larger heat sink 192 and fan 193, circular as shown above. As before, the heat sink is connected directly to the LED array in intimate heat conducting contact with it, to maximize heat transfer to the fins of the heat sink.

As in the work light of FIGS. 9-11, the heat-sink is located immediately behind the LED light source and behind the inner opening of the reflector at the center of the reflector.

The power supply or supplies for the lamps 168 and 170 are not shown because they are the same as those shown and described above for the other embodiments of the invention. There is ample room in the module 166 in which to mount the power supplies.

Although separate power supplies can be provided for each of the two headlamps, a single power supply could be used for both, if desired.

When the LED lamps shown in FIGS. 12-14 are used instead of halogen or incandescent lights, the electrical power used and, hence, the gasoline used to energize the headlamps is reduced, thus increasing gasoline mileage for the vehicle, and providing very bright light. Furthermore, the bulbs last for a very long time, probably longer than the car.

If desired, a battery back-up system, to be described below, can be provided for each of the headlights.

### Battery Back-Up

An optional feature of the invention is to provide battery back-up for operation of the automobile headlight and any of the other lamps described herein.

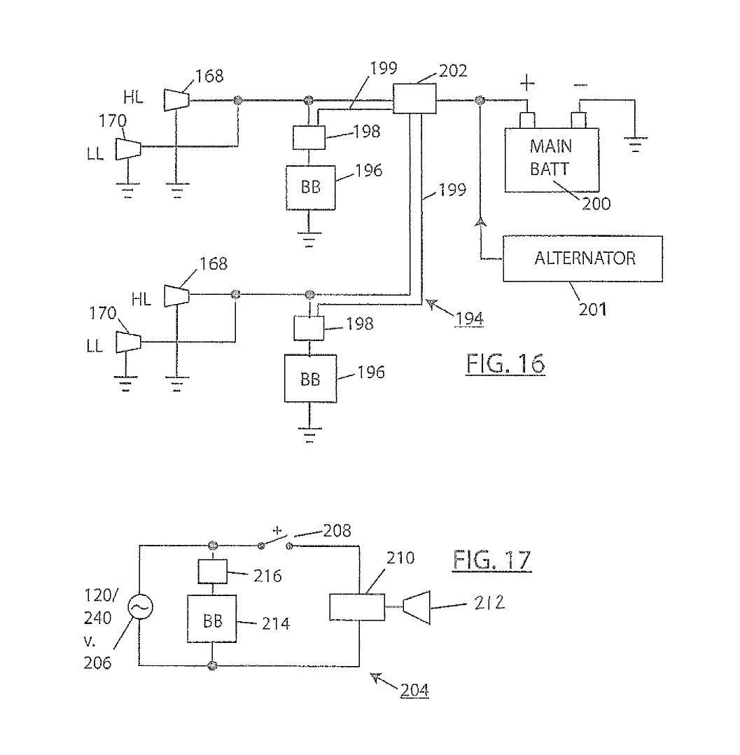

FIG. 16 is a schematic circuit diagram for a battery back-up circuit 194. FIG. 16 does not show the entire electrical circuit of an automobile, but only the part relevant to the feature here described.

The circuit includes the main battery 200 of the automobile, the alternator of the automobile, the light switching device 202 to switch the lights on and off, and to switch from dim to bright and bright to dim, etc. Both the high beam lamp 168 and the low beam 170 are connected to the switch 202. Connected between the headlamp and the switch 202 is a series combination of an electrical level sensing circuit 198 and a back-up rechargeable battery 196.

The back-up battery advantageously can consist of one or more low-voltage rechargeable batteries, such as those producing 4000 mAh protected lithium-ion rechargeable batteries. Any other batteries suitable to the task also can be used. Such batteries are relatively low-cost and can store adequate energy to continue the operations of the LED headlights 168 and 170 for up to an hour and a half or longer after the automobile battery 200 ceases to supply energy.

The device 198 senses the voltage supplied by the main battery 200. When that voltage drops below a predetermined level, such as when the battery dies and the alternator 202 is not running, and the light switch 202 is turned on, the device 198 forms an electrical connection of the back-up battery 196 to the lamps 168 and 170. The condition of the switch 202 is delivered to the devices 198 over lines 199.

Thus, if the headlights switch 202 is off, the back-up battery system will be inactive and will not light the headlights. However, if the switch 202 is on, and the voltage sensed by the device 198 is too low, the back-up battery is enabled to supply the relatively low power and voltage needed for the LED power supplies to continue enabling them to provide light. This can be very valuable in times of emergencies.

A similar circuit 204 is shown in FIG. 17 for providing battery back-up service for the other lamps described in this patent application which are supplied with AC voltage from a connection to the power grid 206 or other AC source.

A circuit 216 and a back-up battery unit 214 are connected in series. When the light switch 208 is closed, but the electrical power level falls below a predetermined minimum sensed by circuit 216, the back-up battery 214 is connected to supply energy to the power supply 210 for the LED lamp 212.

At all times, when the power supply is operating normally, the back-up battery 214 is recharged by the power supply 206.

Similarly, the back-up batteries 196 shown in FIG. 16 are recharged when the main battery 200 of the automobile is working normally.

### Battery-Powered Portable Lights

Battery-powered portable lights using the present invention can take a number of different forms, including flashlights, lanterns, and a variety of outdoor lighting products. The compact, efficient, relatively low-cost construction provided by the invention can reduce the size and weight, and the cost of those products.

### Flashlight

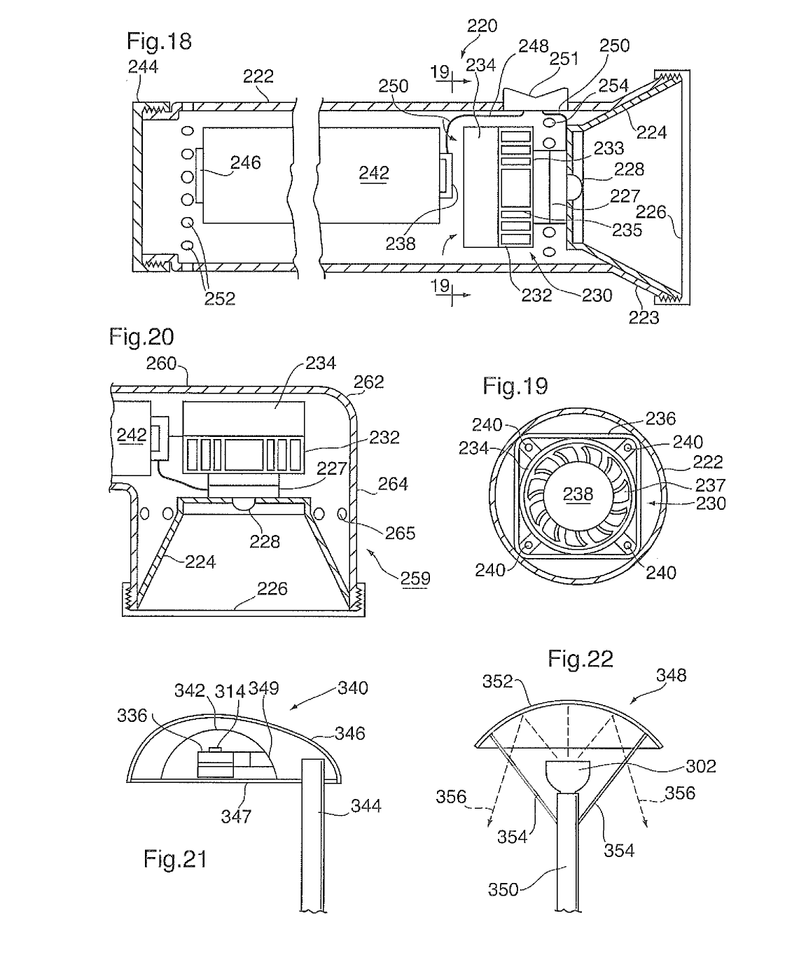

FIG. 18 is a cross-sectional, partially broken-away and partially schematic view of an in-line flashlight 220 using the invention. The term “in-line” is used here to distinguish the flashlight of FIG. 18 from the one shown in FIG. 20, in which the light beam from the flashlight emerges in a direction perpendicular to the longitudinal axis of the handle.

Referring to FIGS. 18 and 19, the flashlight 220 includes an elongated housing 222 with a flared right end 223, a reflector 224 for forming light emitted by an LED through a lens 228 into a beam extending axially from the flashlight. A transparent cover 226 is provided.

Mounted inside the housing 222 is a fan and heat sink unit 230 consisting of a fan 234 and a heat sink 232 mounted in heat-conducting contact with the substrate of the LED through a conductive contact structure 227. The heat sink and fan combination preferably is mounted in the housing 222 by conventional mounting means which is not shown in the drawings.

As it can be seen in FIG. 19, the outline of the fan-heat sink unit 230 is square. A circular structure can be used, if desired, so as to allow the reduction of the diameter of the housing 222.

A rechargeable battery 242 such as a lithium-ion type is provided for supplying energy to the LED and the fan. As it is well-known, a driver circuit such as those used in the AC powered units described above is not necessary. Preferably, the voltage of the rechargeable battery is selected to be within the same range as that needed for operating both the fan and LED.

Means such as a recharging receptacle (not shown) accessible from outside the housing 222 is provided for recharging the rechargeable batteries, as it is well-known in the art. Alternative recharging means are described below and shown in FIG. 26.

The fan and heat sink unit 230 includes the fan 234 mounted on top of the heat sink 232. Preferably, the fan is an axial fan which directs its air flow to the right in FIG. 18, in the direction of the heat sink 232. The air from the fan flows through the main portions of the heat sink, and then outwardly from the sides of the heat sink.

The warm air from the heat sink is exhausted from the housing through outlets 254 which are nearby. Further ports 252 are provided in the opposite end of the housing to provide an inlet for outside air.

A threaded closure cap 244 is provided at the left end of the housing 222 to give access to the interior of the housing to replace the battery 242, if needed.

A structure 246, 238 is provided to mount the battery. This structure is not shown in detail because it is well-known in the art.

An on-off switch 251 is provided, and conductors 250 and 248 lead from the battery through the switch to the LED and to the fan motor so that both are driven by the same battery.

Referring to FIG. 19, the fan 234 has a motor 238 with fan blades 237 encircled by a cowling 234 and a square mounting frame 236. The fan is mounted on the heat sink 232 by means of screws inserted through holes 240 which fit into the crevices between the upstanding fins 235 of the heat exchanger. The heat exchanger has a conductive bottom plate 233 to which the LED array is secured.

The flashlight shown in FIG. 18 is highly advantageous in that all of the heat sink and fan structure is contained inside the body of the flashlight. Furthermore, the structure is relatively small and light weight, as it has been described above. The light output from the flashlight is relatively high-powered, and yet the LED does not overheat and burn out.

FIG. 20 is similar to that of FIG. 18, showing a right-angle flashlight 259, which is essentially the same as the flashlight 220 shown in FIG. 18, except that it has a housing which has a right-angle end section 264 with vent holes 265.

The flashlight shown in FIG. 20 is advantageous in that the handle of the flashlight can be smaller in diameter than that shown in FIG. 18. Furthermore, such right angle flashlights are considered superior for certain lighting uses.

It should be understood that the power supply for the flashlights described above need not be rechargeable batteries. Ordinary dry cells can be used, if desired.

FIG. 26 shows an alternative method for recharging a rechargeable battery. A solar panel 362 is connected by a cable 364 to a rechargeable battery 366. This arrangement is particularly useful when using the light source in a remote area where there are no power grids to use in recharging.

### Lantern

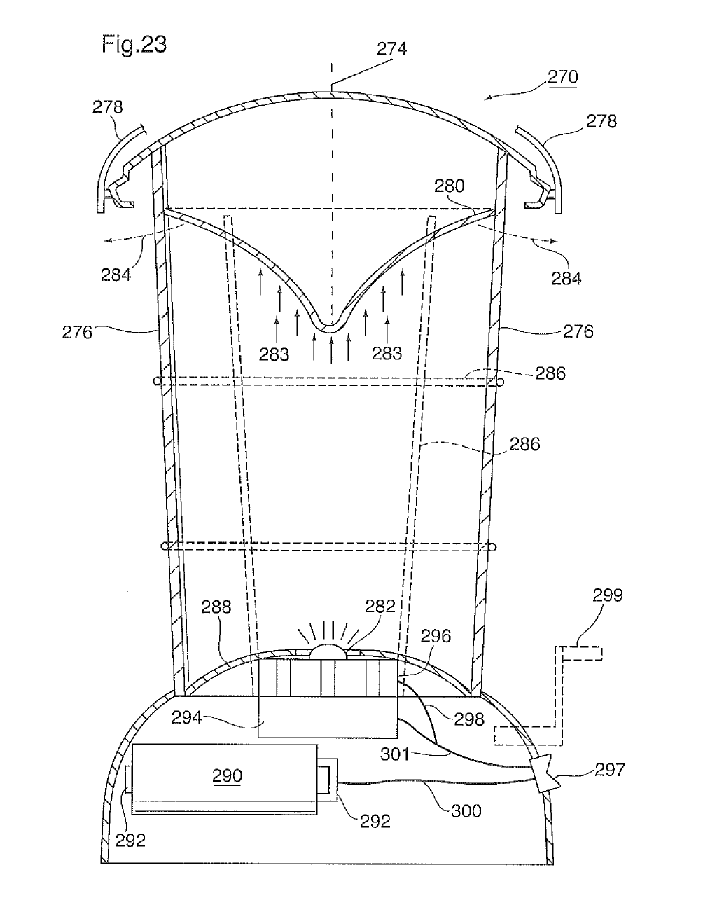

Shown in FIG. 23 of the drawings is a lantern 270, which is of a known construction, except for the novel LED light source with fan and heat sink. The lantern 270 can be used anywhere a portable lighting device is useful, such as outdoor, backyard lighting, picnics, camps, etc.

The lantern 270 includes a base 272, a cover 274, a transparent side wall 276 which is slightly frustro-conical in shape, a lower reflective surface 288 with a hole in the center, and an upper reflector 280 which reflects the light from an LED lens 282 outwardly to spread it where it can be used. A carrying handle 278 is attached to the top for carrying the lantern. Crossed wire bars 286, shown in dashed lines, are provided on the outside of the transparent housing 276 to protect and support the housing.

A heat sink 296 and a fan 294 combination preferably is the same as the fan and heat sink combination shown in FIGS. 18-20. However, the fan and heat sink can be of any other variety shown and described above or known for use in the cooling of computer components. The LED has a lens 282 and is mounted directly on the heat sink, as in the other embodiments of the invention.

A rechargeable battery 290 is mounted in the base 272 next to the fan and heat sink structure. The battery 290 is mounted in a mounting structure indicated schematically at 292. Electrical leads 298, 300 and 301 are connected through an on-off switch 297 from the battery 290 to the LED and the fan respectively.

As it has been noted above, an alternative power source to the rechargeable battery 290 is a hand-cranked generator, shown schematically at 299, in dashed lines, which is known and available for use in recharging the battery.

Alternatively, ordinary means (not shown) are provided for plugging the rechargeable battery to a household current outlet, etc.

Also, the solar panel 362 shown in FIG. 26 can be used to generate electricity to recharge the lantern battery.

The air flow from the fan 294 exits the heat exchanger 296 into the base 272 and escapes the housing through natural crevices such as that at the open bottom of the lower section 272.

### Threaded Lamps

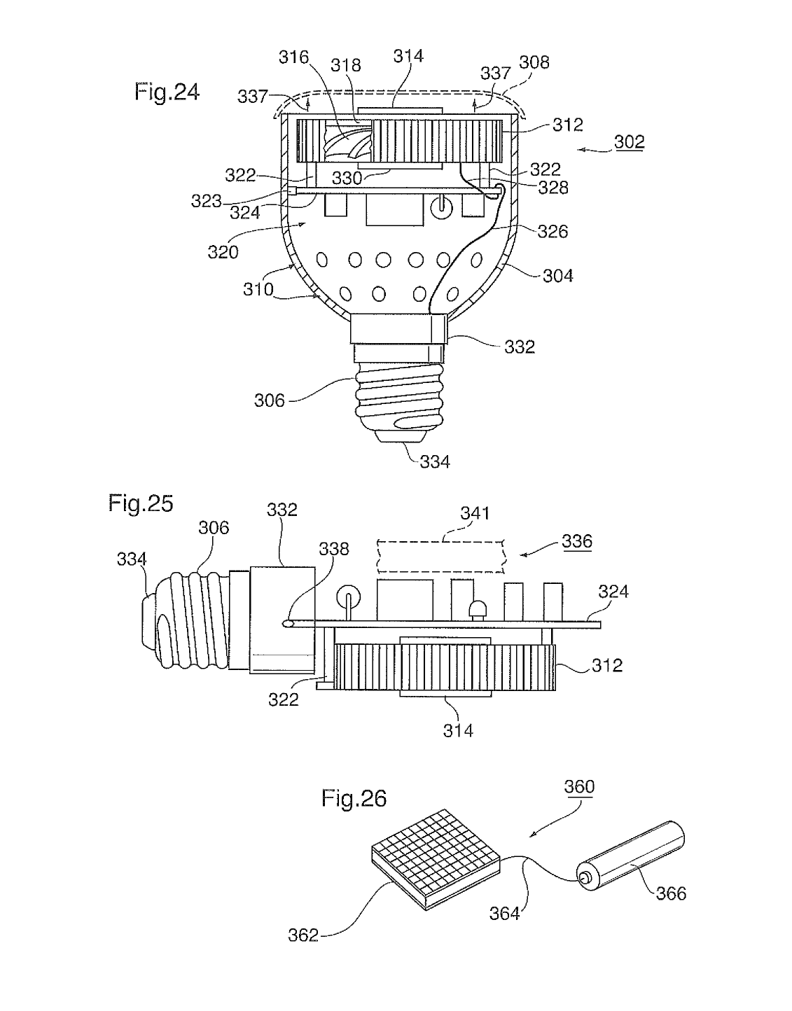

FIG. 24 shows a threaded lamp which is intended for use in replacing a threaded light bulb such as an incandescent, halogen or fluorescent light bulb. The lamp 302 consists of a housing 304, preferably of metal, with a threaded connector 306 having an electrical contact 334. This adapts the lamp to be threaded into an ordinary threaded lamp socket.

The housing 304 is attached to the threaded insert portion 306 by means of an insulating ring 332, and a conductor 326 conducts alternating current from the socket to a driver circuit 320 mounted on a printed circuit card 324. The driver circuit output is connected both to the input of fan motor 330 and to an LED 314. The driver circuit converts the alternating current signals it receives into DC of a voltage satisfactory for both the fan and the LED.

The housing 304 has a hemispherical lower portion with rows of ventilating holes 310 and a straight-wall portion in which the fan and heat sink and driver circuit are mounted.

An outlet cover 308 is shown schematically. It consists of a wire mesh, or other transparent or translucent material which allows air to pass through it easily.

The printed circuit board 324 is secured to the heat exchanger 312 by means of stand-off posts 322. That structure is mounted in the housing 304 by a suitable mounting structure indicated schematically at 323.

The heat sink 312 is a heat exchanger which is circular in outside shape and has an axial fan whose blades are shown at 316 through a broken-out section of the heat sink.

The heat sink is a unitary structure having a base plate 318 and multiple radially-extending fins. The height of the fins is close to that of the fan blade rotating inside of it, thus forming a very compact structure which can minimize the size of the lamp. In fact, the housing 304 shown in FIG. 24 is taller than need be to incorporate the fan, heat sink, and driver, but is shown as depicted in the figure so as to ensure clarity in the illustration.

The LED source 314 preferably includes a lens to shape the light output of the lamp as desired. The light shines upwardly, as shown in FIG. 24, and the air flow out of the heat exchanger also moves upwardly. Air is taken in through the vent holes 310. The axial flow of air helps to keep the lamp structure relatively simple and inexpensive to manufacture, because of avoiding the use of slots or other ports in the exhaust end of the housing, and also is believed to prevent or minimize any tendency of the air to flow backwardly toward the inlet openings 310.

FIG. 25 shows another threaded lamp embodiment of the present invention. The parts of the lamp 336, which are the same as in FIG. 24 are given the same reference numerals. There is no housing corresponding to the housing 304, but the lamp 336 is designed to use reflectors and fixtures in which the light shines generally in a direction perpendicular to the longitudinal axis of the threaded element 306. Thus, both the air flow and the light produced by the lamp 336 extend downwardly in the drawing. The printed circuit board 324 is attached to the insulator 332 as indicated at 338.

### Luminaires

FIGS. 21 and 22 are schematic and partially cross-sectional drawings showing luminaires or lamp fixtures in which the lamps 302 and 336 can be used.

FIG. 21 shows a cobra-type street luminaire or light fixture 340 with an outer housing 346 mounted on a post 344, a transparent cover 347, and a light fixture 346 such as that shown in FIG. 25. A reflector 342 is provided and a threaded socket 349 is provided into which the lamp is threaded.

The lamp 340 shown in FIG. 41 is representative of desk lamps and other lamps of a similar type in which the socket for the bulb extends horizontally with respect to a reflector. The light shines upwardly from the LED unit 314 to be reflected off the reflector and spread downwardly. However, the lamp 336 can be rotated 180° to shine downwardly, if desired.

It also should be understood that the fixture 336 shown in FIG. 25 also can include a second heat sink and fan unit, indicated schematically in FIG. 25 at 341, so that light shines both upwardly and downwardly from two separate LED sources.

FIG. 22 shows an umbrella-type luminaire or light fixture 348 using the lamp 302 screwed into a socket in the top of a post 350. A reflector cover 352 is supported on the post by supports 354. Light from the lamp 302 is reflected off of the reflector 352 and downwardly in the direction indicated by the arrows 356.

It also should be understood that the lamp 302 simply can be used to replace an existing bulb in a down lamp fixture of the type shown in FIG. 1, etc.

Other heat sink and fan combinations, preferably those used in personal computers, laptops, etc., can be used instead of those listed above.

### Method of Manufacture

The method of manufacturing the foregoing LED lamps includes the following steps and features.

First the amount of light needed, the spectral characteristics and other characteristics of the LED light source are to be determined, and the heat to be dissipated to keep the temperature of the source at or below a desired temperature, e.g. 65° C., is determined.

Next, a fan and heat exchanger combination as supplied for cooling computer cards such as VGA cards, CPUs and other computer components is selected by the amount of heat it is specified to dissipate, its physical size and shape, the temperature it will maintain, and the rated life of the fan; e.g. 20,000 hours, 50,000 hours, etc. The temperature which the cooling unit will maintain and the hours rating should be as needed to ensure the temperature of the LED will be maintained and the life of the fan will be at least as long as the life desired for the LED. For example, the fan should be rated to last at least 50,000 hours if that is the desired life of the LED.

The physical structure of the LED cooling unit also should be chosen to fit the lamp structure.

The fan and heat sink structure can be modified as necessary to fit into the housing of the lamp, and otherwise, as needed.

The same manufacturing method can be implemented by obtaining new units made specifically for the LED but using the components of a computer cooling unit.

The result is a relatively low cost, compact LED lamp which will allow continuous operation for a relatively long time due to superior cooling of the LED source.

### Specifications

The following LED arrays are typical examples of arrays which can be used. All specifications are those stated by the manufacturer or seller, and should be verified by actual test.
20 Watt—white LED; brightness 1000 Lm
50 Watt—white LED; brightness 3500 Lm
100 Watt—white LED; brightness 8000 Lm

Following are the manufacturer's or seller's specifications of suitable fans and heat sinks:
Fan and heat-sink in FIGS. 1-5 and 12-15:
Snowflake DC Brushless Cooling fan for PC VideoCard
Fan and heat-sink in FIGS. 6-8:
3000 RPM Quiet CPU Fan (12V DC).
FIGS. 9-11:
“Super Silent Professional Video Card Heat Pipe Cooler” with 2500 RPM form, Part #41214, dealextreme.com

The fan and heat sink should be selected to be rated to operate for at least as long as the useful life desired for the LED array.

The above description of the invention is intended to be illustrative and not limiting. Various changes or modifications in the embodiments described may occur to those skilled in the art. These can be made without departing from the spirit or scope of the invention.

1. A method of making an LED lamp, said method comprising
a. providing an LED array light source for said lamp,
b. providing a computer component cooling device comprising a heat sink and fan unit provided for cooling components in computers, said fan and said heat sink being matched to one another to provide cooling sufficient for protecting computer cards or other computer devices from overheating,
c. said heat sink having a heat-exchanging structure with a surface for mounting said array thereon in heat-conducting contact with said heat-exchanging structure,
d. said fan being mounted directly on said heat sink and being adapted to move air over said heat exchanging structure to cool said array,
e. providing an electrical connection device to connect an electrical power source to said LED array, and to power said fan,
f. modifying said fan and heat sink unit as necessary for fitting said unit into a lamp housing, and
g. mounting said fan, heat sink and attached LED array in said lamp housing with said LED array positioned to direct light out of said housing.

2. A method as in claim 1 including the step of selecting said fan and heat sink unit from the group consisting of (1) a fan with cowling mounted on the outside surface of said heat sink unit, and (2) a fan without a cowling mounted in a recess in said heat sink structure, said fan being a rotary-bladed fan with said fan having approximately the same height as said heat-sink structure.

3. A method as in claim 1 in which said heat exchanging structure is selected from the group consisting of (1) heat-conducting fins, (2) heat pipe or pipes, (3) a combination of fins and heat pipe or pipes.

4. A method as in claim 1 including the step of providing electrical conversion circuitry for converting standard AC current to DC current at a voltage correct to supply both said LED array and said fan.

5. A method as in claim 1, said computer component cooling device being constructed and rated to operate satisfactorily for a first specified number of hours, said LED array being rated to operate satisfactorily for a second specified number of hours, said first number being at least approximately equal to said second number.

6. A method as in claim 5 in which said second specified number is specified at a predetermined number or range of numbers for the operating temperature of said array, and said cooling device is rated to maintain the temperature of said array within said range of numbers or approximately at said predetermined number when said lamp is operated continuously over more than one calendar day.

7. A method as in claim 1 including providing a reflector and mounting it in said housing to reflect the light from said array in a desired pattern.

8. A method as in claim 1 including mounting a DC power supply in said housing, said power supply being selected from the group consisting of (1) at least one battery; and (2) at least one rechargeable battery, and (3) a manually operated hand-crank generator.

9. A method as in claim 4 including mounting said converting circuitry board, securing said board to a threaded connector for threading into a threaded receptacle, and attaching said heat sink and fan unit to said board.

10. An LED lamp comprising
a. an LED array light source for said lamp,
b. a computer component cooling device comprising a heat sink and fan unit provided for cooling components in computers, said fan and said heat sink being matched to one another to provide cooling sufficient for protecting computer cards or other computer devices from overheating,
c. said heat sink having a heat-exchanging structure with a surface for mounting said array thereon in heat-conducting contact with said heat-exchanging structure,
d. said fan being mounted directly on said heat sink and being adapted to move air over said heat exchanging structure to cool said array,
e. an electrical connection device to connect an electrical power source to said LED array, and to power said fan,
f. said fan, heat sink and attached LED array being mounted in said lamp housing with said LED array positioned to direct light out of said housing.

11. A device as in claim 10 including a portable electrical power supply in said housing for supplying electrical power to said LED and said fan, (1) at least one battery; and (2) at least one rechargeable battery; (3) a manually operated hand-crank generator and (4) a solar panel with a rechargeable battery.

12. A device as in claim 10 in which said housing forms an elongated handle with a battery compartment therein and a reflector and LED element adjacent to one end of said housing, and an on-off switch to selectively enable said lamp.

13. A device as in claim 10 in which said housing has a transparent side wall and a lower portion below and an upper portion above said side wall, said LED element being located adjacent to said lower portion and being positioned to beam light towards said upper portion, and a reflector being located adjacent to said upper portion and being shaped and positioned for spreading said light outwardly through said side wall.

14. A device as in claim 13 including a carrying handle secured to said upper portion, said lower portion having a base for supporting said lamp on a horizontal support surface.

15. A threaded LED lighting unit comprising
(a) a support structure and, mounted on said support structure,
(b) a threaded male electrical connector adapted to be threaded into a threaded lamp socket, said connector being connected to and extending outwardly away from said support structure,
(c) a computer fan and heat sink structure having a heat exchanger, said heat sink being secured to said support structure, said fan and said heat sink being matched to provide long-lived cooling of computer components,
(d) said fan being mounted on said heat sink structure and positioned to force air to flow through said heat exchanger,
(e) an LED array mounted on said heat sink so that said heat sink conducts heat away from said array, said fan and heat sink being selected from the group consisting of (1) a fan with cowling mounted on the outside surface of said heat sink unit, and (2) a fan without a cowling mounted in a recess in said heat sink structure, said fan being a rotary-bladed fan with said fan having approximately the same height as said heat-sink structure.

16. A device as in claim 15 including a driver circuit unit electrically connected to said connector, said fan and said LED array, and adapted to convert AC from said connector into DC with a voltage in the proper range to drive said fan as well as said array.

17. A device as in claim 15 including a housing having an open end and a closed end, and having a longitudinal axis, said threaded connector secured to and extending outwardly from said closed end housing, said support being mounted in said housing with said LED beaming light outwardly from said open end of said housing, said fan being positioned and adapted to move air through said heat sink and out of said housing primarily in a direction parallel to said longitudinal axis, said housing having at least one imperforate side wall enclosing said fan and heat sink.

18. A device as in claim 15 including a perforate cover over said open end to protect the lamp components and allow air to flow freely out of said housing, said housing also having at least one air inlet spaced from said open end.
